(19) United States
(12) Patent Application Publication
(10) Pub. No.: US 2022/0006106 A1
(43) Pub. Date: Jan. 6, 2022

(54) BIPOLAR PLATE FOR A FUEL CELL, AND FUEL CELL

(71) Applicants: AUDI AG, Ingolstadt (DE); Volkswagen AG, Wolfsburg (DE)

(72) Inventor: Sebastian KIRSCH, Sassenburg (DE)

(21) Appl. No.: 17/265,156

(22) PCT Filed: Jul. 8, 2019
(86) PCT No.: PCT/EP2019/068220

§ 371 Date: Feb. 1, 2021

(30) Foreign Application Priority Data
Aug. 2, 2018 (DE) 10 2018 212 878.2

(51) Int. Cl. H01M 8/0267; H01M 8/0258; H01M 8/0228

(52) U.S. Cl. CPC H01M 8/0267; H01M 8/0228; H01M 8/0258

(57) ABSTRACT

A bipolar plate for a fuel cell has flow channels for the reactants formed between webs in a plate body, and lines for a coolant, and has hydrophilic structures associated with the plate body formed in a gradient. The gradient of hydrophilic structures is associated with the web with hydrophilicity increasing towards the bottom of the flow channels, wherein microchannels to the flow channels, opening into the flow channels and generating capillary force, are formed in the boundary surface of the webs.

### BACKGROUND

### Technical Field

Embodiments of the invention relate to a bipolar plate for a fuel cell, having flow channels for the reactants formed between webs in a plate body, and having lines for a coolant, and having hydrophilic structures associated with the plate body formed in a gradient. Embodiments of the invention further relate to a fuel cell.

### Description of the Related Art

Fuel cells are used to provide electrical energy with an electrochemical reaction between a fuel, typically hydrogen, and an oxygen-containing gas, typically air. The fuel cell has a membrane electrode assembly with the anode formed on one side of the membrane and the cathode formed on the other side. Hydrogen gas is supplied to the anode, whereas air is supplied to the cathode. Bipolar plates are used for this orderly supply of reactants to the electrodes; in addition to flow channels for the reactants, these bipolar plates also have lines for a coolant.

It should be noted that product water is generated during the electrochemical reaction, which can lead to power losses of the fuel cell if the functional layers present in the fuel cell, namely the membrane electrode arrangement and gas diffusion layers arranged between the bipolar plate and the membrane electrodes, are flooded. As a result, the flow cross-sections in the flow channels are reduced and the suitability of the gas diffusion layers for uniform distribution of the reactants is also impaired.

To eliminate this water flooding the functional layers, it has been common practice to rid the flooded functional layers of the water by adjusting the operating conditions, namely, for example, by setting the volumetric flow rate of the gases high, which, however, leads to reduced efficiency of the fuel cell or to the occurrence of degradation when other operating parameters such as pressure or temperature are adjusted.

In DE 11 2006 000 613 B4, it is proposed to make bipolar plates for a fuel cell hydrophilic, since a hydrophilic plate causes water to form a thin film in the channels, which has a lower tendency to change the flow distribution along the grouping of channels. The hydrophilic properties are generated by an external metal oxide coating.

From US 2005/0221139 A1A, a bipolar plate according to the generic concept of the main claim is known, in which the bipolar plate has a gradient of a hydrophilic structure, wherein the gradient is oriented perpendicular to a planar surface of the bipolar plate.

In DE 10 2008 034 546 A1, as regards a superhydrophilic surface, it is pointed out that a drop of water dropped onto the surface is drawn into available microchannels due to capillary forces and the drop is transported along these microchannels.

### BRIEF SUMMARY

Embodiments of the invention are based on forming a bipolar plate of the type mentioned above in such a way that there is an improved prevention of flooding of the functional layers.

A bipolar plate may be characterized by the fact that there is improved water management, because forces are specifically provided by different physical effects which ensure that the water moves from the edge of the bipolar plate to the bottom of the flow channels, wherein it is in particular recognized that the capillary forces can cause a directed transport of the water into the flow channels, in particular when the microchannels taper in the direction of the associated flow channel.

In principle, it is possible for the bipolar plate to be formed of a hydrophilic material. However, embodiments of the invention are also applicable when the bipolar plate is formed of a hydrophobic material, namely in the case in which the hydrophilic structure is formed as a coating on the webs. As an example, reference may again be made to a metal oxide layer with a suitable arrangement of the particles of the metal oxide.

It may be advantageous if the areal density of the mouths of the microchannels increases from the edge to the bottom of the flow channels, since this in turn promotes the transport of water from the edge region of the bipolar plate to the bottom of the flow channels. It has been shown to be advantageous in terms of manufacturing if the microchannels are oriented perpendicular to the boundary surfaces.

It may also be advantageous if the bottom of the flow channels is more hydrophilic than the webs in their adjacent areas, in order to again favor the transport of the liquid water from the web into the flow channel.

If a fuel cell is allowed to be provided with the bipolar plates as described herein, the product water is rapidly removed from the functional layers adjacent to the bipolar plate, namely the membrane electrode assembly or respectively the gas diffusion layer, so that improved water management is provided for the fuel cell and the efficiency of the fuel cell is increased inasmuch as optimum operating conditions are not necessarily required for the water to be discharged from the flow channels with the volumetric flow of the reactant gases.

An improvement of the water management also causes the bipolar plate to have a higher hydrophilicity in the region of its webs facing the gas diffusion layer than in the gas diffusion layer, since the water can thus be selectively directed from the gas diffusion layer into the webs to subsequently take advantage of the improved water management of the bipolar plate.

### BRIEF DESCRIPTION OF THE SEVERAL VIEWS OF THE DRAWINGS

Further advantages, features, and details are disclosed in the claims, the following description, and the drawings.

FIG. 1 shows a schematic representation of a cross-section through a fuel cell.

FIG. 2 shows a representation corresponding to the one in FIG. 1 of another fuel cell.

FIG. 3 shows a schematic representation of the increase in hydrophilicity from the web to the flow channel.

FIG. 4 shows a representation corresponding to the one in FIG. 3 with the tapering microchannels associated with the webs.

### DETAILED DESCRIPTION

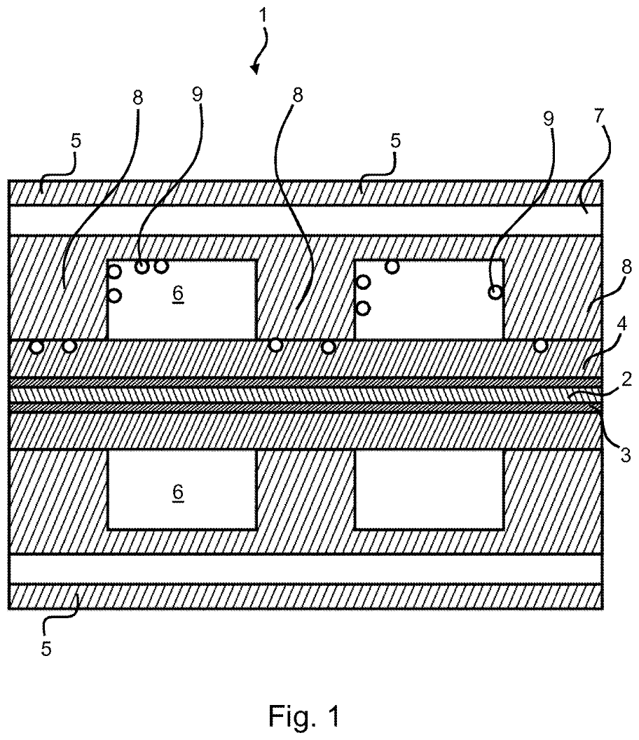

In FIG. 1, a fuel cell is shown as part of a fuel cell stack, whereby it should be noted that the fuel cell stack is formed from a plurality of fuel cells stacked one on top of the other in a stacking direction.

The fuel cell 1 comprises an anode and a cathode, and a proton-conductive membrane 2 that separates the anode from the cathode, which are all combined in a membrane electrode assembly 3. The membrane 2 is formed of a polymer, such as a sulfonated tetrafluoroethylene polymer (PTFE) or a perfluorinated sulfonic acid (PFSA) polymer. Alternatively, the membrane 2 may be formed as a hydrocarbon membrane.

A catalyst can additionally be admixed in the anodes and/or in the cathodes, wherein the membranes 2 may be coated on their first side and/or on their second side with a catalyst layer of a noble metal or of mixtures comprising noble metals such as platinum, palladium, ruthenium, or the like, which serve as reaction accelerators in the reaction of the respective fuel cell.

Hydrogen-containing fuel is supplied to the anode compartment of a fuel cell 1. In a polymer electrolyte membrane (PEM) fuel cell, hydrogen is split into protons and electrons at the anode. Membrane 2 allows the protons to pass through, but is impermeable to the electrons. Whereas the protons pass through Membrane 2 to the cathode, the electrons are sent to the cathode or to an energy storage device via an external circuit.

Oxygen or oxygen-containing air is supplied to the cathode compartments of a fuel cell 1, so that the following reaction takes place on the cathode side: O₂+4H⁺+4e⁻ →H₂O.

The electrochemical reaction taking place in a fuel cell 1 results in the generation of product water.

On both sides of the membrane electrode arrangement 3, the fuel cell 1 has, on the one hand, gas diffusion layers 4 and, on the other hand, bipolar plates 5 in which, on the one hand, flow channels 6 for the reactants and, on the other hand, lines 7 for a coolant are formed. The bipolar plates 5 are thus used to conduct the hydrogen and oxygen to the membrane electrode arrangement 3 and to distribute them uniformly with the aid of the gas diffusion layer 4.

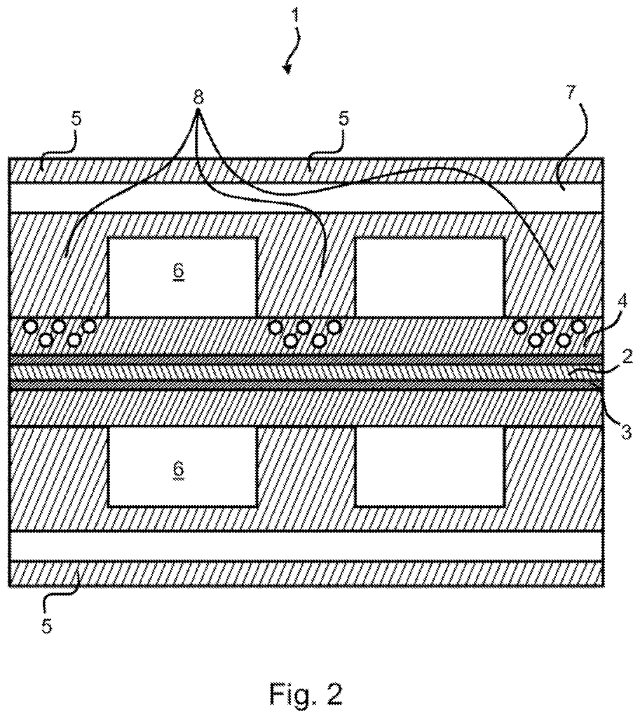

FIG. 2 schematically shows a fuel cell 1 known from the prior art, in which liquid water 9 symbolized as dots accumulates under the webs 8 of the bipolar plate 5, so that the gas transport is impeded in the gas diffusion layer 4.

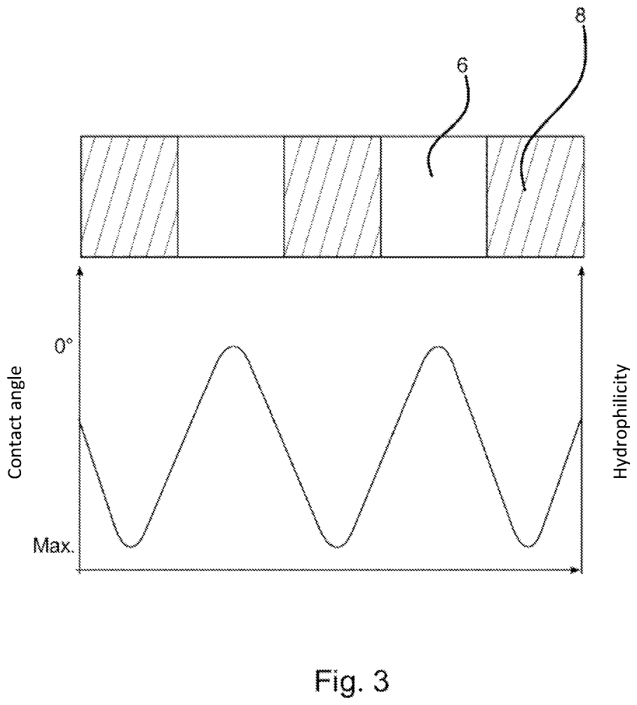

FIG. 1 shows a fuel cell 1 in which bipolar plates 5 are used, in which hydrophilic structures formed in a gradient are present, which are associated with the webs 8. FIG. 3 shows the increase in hydrophilicity from web 8 to channel 6, so that a force acting on the liquid water 9 results, which directs the liquid water 9 to the bottom of the flow channels 6.

In this regard, the production of the gradient can take place in a metal bipolar plate 5 during the radiated input of the corresponding oxides into the plate blank. In the case of graphite bipolar plates 5, different wetting times can be used in the chemical deposit of the corresponding oxides on the formed bipolar plate 5.

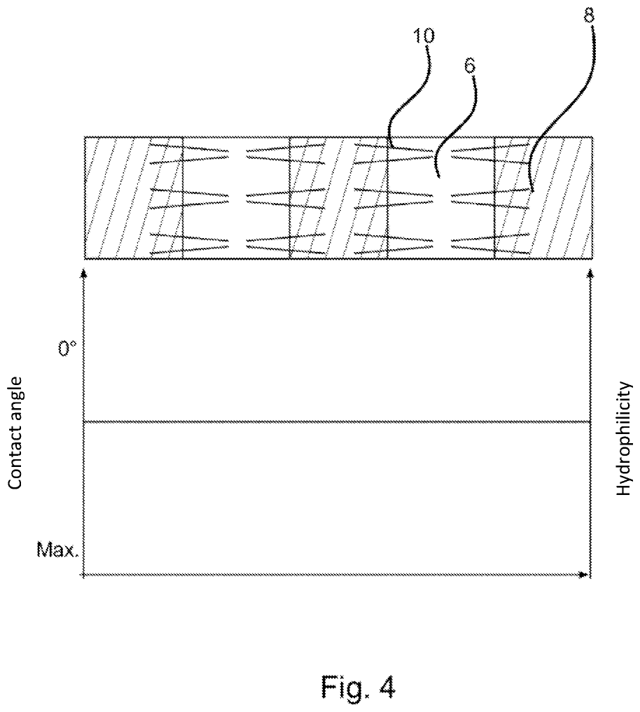

FIG. 4 shows that even with constant hydrophilicity, a force directed from the webs 8 into the flow channels 6 can be provided, namely by tapering microchannels 10, which can be fabricated in the bipolar plates 5 by removal of material by laser or by mechanical processing or by appropriate geometrical shaping in the casting or pressing tool.

Embodiments of the invention provide a superimposition of these two effects shown in FIGS. 3 and 4, wherein FIG. 4 shows that the microchannels 10 are oriented perpendicular to the boundary surface of the flow channels 6 with a constant areal density of the mouths of the microchannels 10. It is also possible that the areal density of the mouths of the microchannels 10 increases from the edge to the bottom of the flow channels 6, so as to thereby impose an advantageous direction on the transport of the water.

As symbolically represented in FIG. 1, the bottom of the flow channels 6 is more hydrophilic than the webs 8 in their adjacent areas, so that it also results that the liquid water 9 is transported to the bottom of the flow channels 6 to promote its discharge with the gas flow.

It should moreover be noted that the bipolar plates 5 have a higher hydrophilicity in the area of their webs 8 associated with the gas diffusion layer 4 than in the gas diffusion layer 4, in order to bring about a targeted relief of the functional layer threatened by flooding and to be able to exploit the advantages of the improved bipolar plate 5 with regard to water management.

In general, in the following claims, the terms used should not be construed to limit the claims to the specific embodiments disclosed in the specification and the claims, but should be construed to include all possible embodiments along with the full scope of equivalents to which such claims are entitled.

1. A bipolar plate for a fuel cell, comprising:
flow channels for reactants formed between webs in a plate body;
lines for a coolant; and
hydrophilic structures arranged in a gradient associated with the plate body,
wherein the gradient of hydrophilic structures is associated with the webs with hydrophilicity increasing towards bottoms of the flow channels, and
wherein microchannels to the flow channels, opening into the flow channels and generating capillary force are formed in boundary surfaces of the webs.

2. A bipolar plate according to claim 1, wherein the bipolar plate is formed of a hydrophilic material.

3. A bipolar plate according to claim 1, wherein the hydrophilic structures are formed as a coating of the webs.

4. A bipolar plate according to claim 1, wherein areal density of the mouths of the microchannels increase from edges to the bottoms of the flow channels.

5. A bipolar plate according to claim 1, wherein the microchannels are oriented perpendicular to the boundary surfaces.

6. A bipolar plate according to claim 1, wherein the bottoms of the flow channels are more hydrophilic than the webs in adjacent areas.

7. A fuel cell, comprising:
a membrane electrode arrangement;
a first bipolar plate on a first side of the membrane electrode arrangement, the first bipolar plate including:
first flow channels for a first reactant formed between first webs in a first plate body;
first lines for a coolant; and
first hydrophilic structures arranged in a gradient associated with the first plate body,
wherein the gradient of first hydrophilic structures is associated with the first webs with hydrophilicity increasing towards bottoms of the first flow channels, and
wherein microchannels to the first flow channels, opening into the first flow channels and generating capillary force are formed in boundary surfaces of the first webs;
a second bipolar plate on a second side of the membrane electrode arrangement, the second bipolar plate including:
second flow channels for a second reactant formed between second webs in a second plate body;
second lines for the coolant; and
second hydrophilic structures arranged in a gradient associated with the second plate body,
wherein the gradient of second hydrophilic structures is associated with the second webs with hydrophilicity increasing towards bottoms of the second flow channels, and
wherein microchannels to the second flow channels, opening into the second flow channels and generating capillary force are formed in boundary surfaces of the second webs;
a first gas diffusion layer arranged between the membrane electrode arrangement and the first bipolar plate; and
a second gas diffusion layer arranged between the membrane electrode arrangement and the second bipolar plate.

8. The fuel cell according to claim 7 wherein the first and second bipolar plates exhibit greater hydrophilicity in areas of the webs facing the gas diffusion layer than in the gas diffusion layer.
